(19) United States
(12) Patent Application Publication
(10) Pub. No.: US 2005/0048840 A1
(43) Pub. Date: Mar. 3, 2005

(54) Electrical connector having improved shielding shell

(76) Inventor: Guozeng Zhang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/927,714

(22) Filed: Aug. 27, 2004

(30) Foreign Application Priority Data
Aug. 27, 2003 (CN) 03278207.1

(51) Int. Cl. H01R 13/648

(52) U.S. Cl. 439/607

(57) ABSTRACT

An electrical connector includes an insulative housing (1) defining a number of passageways (13) thereon, a number of contacts (2), and a shielding shell (3) enclosing the insulative housing. The shielding shell includes two opposite lateral walls (31) connected by a top wall (32) and a bottom wall (33), and a chamber (36) defined by the top wall, the bottom wall and the lateral walls. The top wall and the bottom wall each form a pair of resilient tabs (35) extending within the chamber. The resilient tab has a curved portion (351) protruding into the chamber with a free end extending outwardly toward corresponding top/bottom wall. A pair of guiding portions (34) are respectively formed beside corresponding resilient tabs.

### BACKGROUND OF THE INVENTION

1. Field of the Invention

The present invention generally relates to an electrical connector, and more particularly to a Universal Serial Bus (USB) connector having an improved shielding shell.

2. Description of Prior Art

A conventional USB connector is widely used in high speed signal transmission. U.S. Pat. Nos. 5,738,554, 5,725,386 and 6,475,033 each disclose a conventional USB connector. The connector comprises an insulative housing, a plurality of contacts assembled to the insulative housing and a shielding shell. The shielding shell comprises two lateral walls connected by a top wall and a bottom wall. A chamber is defined by the top wall, the bottom wall and the lateral walls. A pair of resilient tabs are stamped respectively from the top/bottom wall to form a ground way for ejecting useless signal data from the connector to thereby ensure a stable signal transmission between the connector and a mating connector. A pair of resilient pads are stamped from the two lateral walls for engaging with the mating connector.

Each resilient tab has a curved portion formed on a front portion thereof and extending within the chamber. A free end of each curved portion is substantially coplanar with the top wall or the bottom wall where the corresponding resilient tab is stamped. As the connector engages with the mating connector, a shell of the mating connector is inserted into the chamber of the connector by guiding of the free end of the curved portion. The curved portion is pressed by the shell of the mating connector. As the shell of the mating connector is inserted into the chamber deeply, the curved portion of the resilient tab is caused to move outwardly and outspreads beyond corresponding top wall or the bottom wall. Obviously, the engaged connectors need to occupy a relatively big space in a system where the connectors are employed. It is not suitable for being used in some circumstances such as in a notebook.

Hence, an improved electrical connector is required to overcome the disadvantages of the prior arts.

### SUMMARY OF THE INVENTION

Accordingly, it is an object of the present invention to provide an electrical connector occupying a relatively small space after mating with a mating connector.

In order to achieve the object set forth, an electrical connector in accordance with the present invention comprises an insulative housing defining a plurality of passages thereon, a number of contacts, and a shielding shell enclosing the insulative housing. The shielding shell comprises two lateral walls connected by a top wall and a bottom wall, and a chamber defined by the top wall, the bottom wall and the lateral walls. The top wall and the bottom wall each form a pair of resilient tab extending within the chamber. The resilient tab has a curved portion protruding into the chamber with a free end extending outwardly toward corresponding top/bottom wall.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector in accordance with the present invention;

FIG. 2 is a partially exploded, perspective view of the electrical connector in accordance with the present invention;

FIG. 3 is a view similar to FIG. 1, but taken from a different aspect; and

FIG. 4 is a front elevational view of FIG. 1.

### DETAILED DESCRIPTION OF THE INVENTION

Reference will now be made in detail to the preferred embodiment of the present invention.

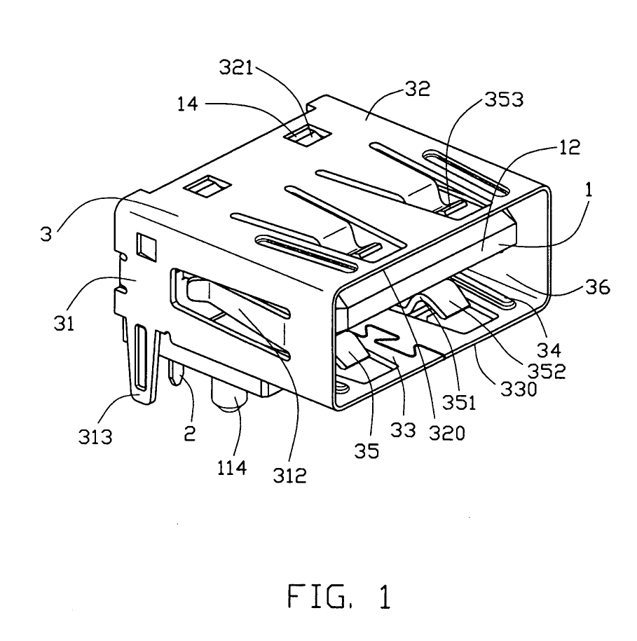

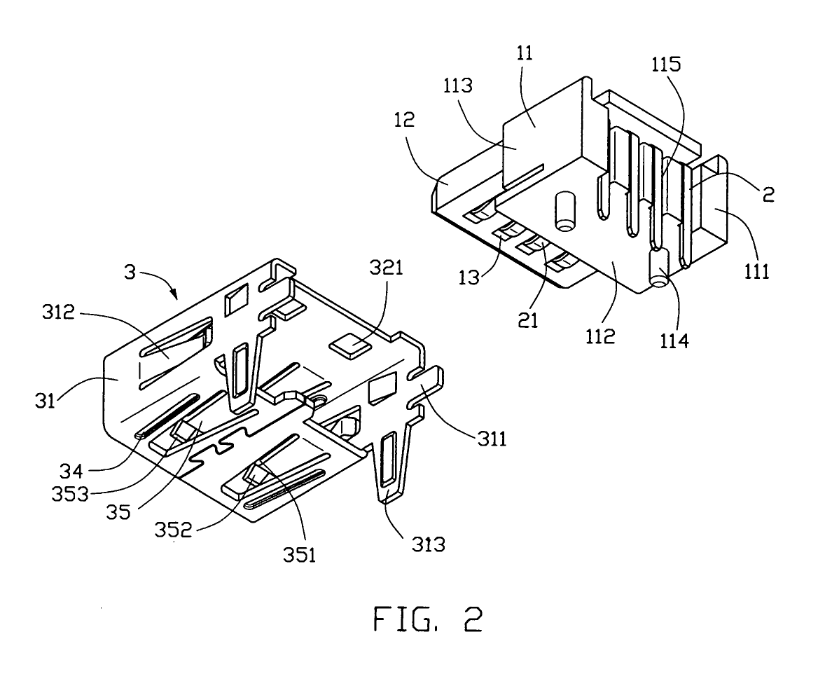

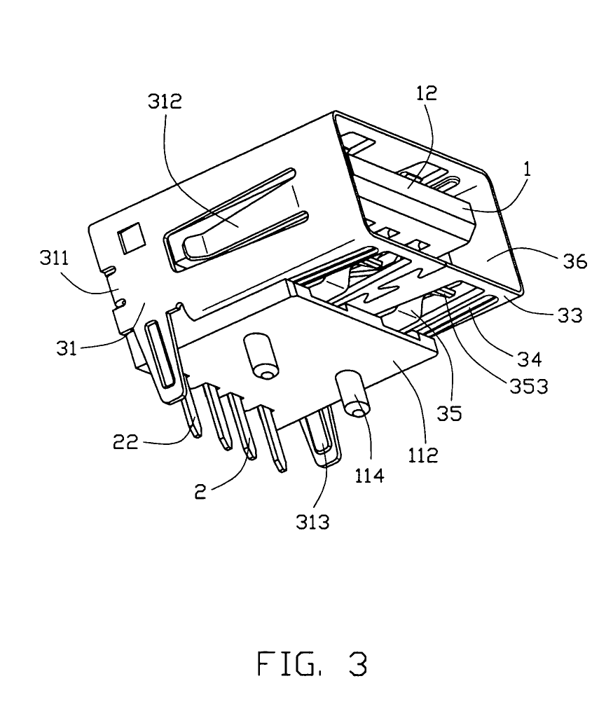

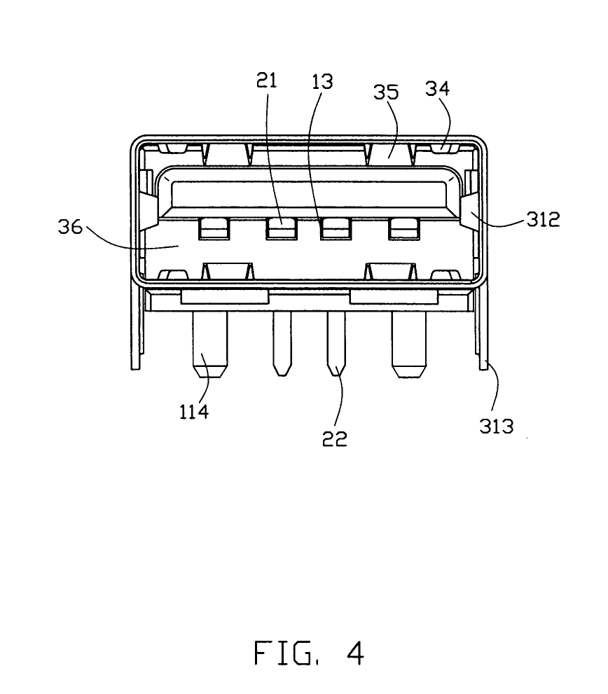

Referring to FIGS. 1-4, an electrical connector (not labeled) in accordance with the present invention comprises an insulative housing 1, a plurality of contacts 2 retained in the housing 1, and a shielding shell 3 enclosing the insulative housing 1.

The insulative housing 1 comprises a base section 11 having a top face (not labeled), a rear face 111, a bottom face 112, two side faces 113 and a front face (not labeled) from which a mating section 12 forwardly extends. A plurality of passageways 13 is formed in a lower face of the mating section 12 for receiving the contacts 2. Each contact 2 has an engaging portion 21 for electrically engaging with a mating connector (not shown) and a tail portion 22 extending perpendicularly from the engaging portion 21 and beyond the bottom face 112 of the base section 11 for electrically connecting with a printed circuit board (PCB, not shown). A pair of standoffs 114 extend downwardly from the bottom face 112 of the housing 1.

The shielding shell 3 comprises two lateral walls 31 connected by a top wall 32 and a bottom wall 33. A chamber 36 is defined by the walls 31, 32, 33 for receiving the insulative housing 1. Two pairs of resilient tabs 35 are respectively stamped from the top wall 32 and the bottom wall 33, and a pair of guiding portions 34 are respectively formed at opposite outer sides of the resilient tabs 35. The resilient tabs 35 and the guiding portions 34 extend along a mating direction of the electrical connector and the mating connector. Each resilient tab 35 comprises a curved portion 351 extending within the chamber 36 with a free end 352 extending outwardly toward corresponding top wall 32 or bottom wall 33. The free end 352 is partially cut to form a cut portion 353, thus, the free end 352 is lower/higher than the top/bottom surfaces of the top and the bottom walls 32, 33. The guiding portion 34 is formed as a rib and a forward end thereof is located nearer to a front edge 320, 330 of the top wall 32 or the bottom wall 33 than the free end 352 of the resilient tab 35. A pair of resilient pads 312 are stamped from the two lateral walls 31 and engage with the housing 1 for retaining the housing 1 in the shielding shell 3. A pair of board mount legs 313 extend downwardly from a rear portion of the lateral walls 31 of the shielding shell 3. A major surface of each board mount leg 313 is substantially coplanar with that of a corresponding lateral wall 31. A pair of tabs 311 respectively extend backwardly from the two lateral walls 31 and are bent to engage with the rear face 111 of the housing 1 for retaining the housing 1 in the chamber 36. A pair of rectangular holes 321 are defined on the top wall 32 near a rear edge thereof and engage with corresponding projections 14 formed on the top face of the housing 1 for securing the shielding shell 3 to the housing 1.

When the electrical connector engages with the mating connector, a shell (not shown) of the mating connector contacts the guiding portions 34 of the electrical connector firstly, and then touches the resilient tabs 35. The guiding portions 34 assure a proper insertion of the mating connector. When the shell of the mating connector is inserted into the chamber 36 deeply, the shell of the mating connector causes the curved portions 351 of the resilient tabs 35 to move outwardly. However, since the cut portions 353 of the resilient tabs 35 are respectively lower/higher than the top/the bottom surfaces of the top and the bottom walls 32, 33, the cut portion 353 of the resilient tab 35 does not outspread beyond the shielding shell 3 of the electrical connector too much. Therefore, the profile of the electrical connector does not expand and the space occupied by the electrical connector decreases.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A Universal Serial Bus (USB) connector, comprising:
an insulative housing defining a plurality of passageways therein;
a plurality of conductive contacts received in the passageways of the insulative housing;
a shielding shell enclosing the insulative housing and integrally comprising two opposite lateral walls, a top wall, a bottom wall, and a chamber defined by the top wall, the bottom wall and the lateral walls; and
at least one of said top and bottom walls formed with a resilient tab extending the chamber, the resilient tab having a curved portion with a free end entirely situated within the chamber.

2. The USB connector as claimed in claim 1, wherein the shielding shell has a guiding portion formed adjacent to the resilient tab and extending along a mating direction of the USB connector.

3. The USB connector as claimed in claim 2, wherein the guiding portion has a forward end extending beyond the free end of the resilient tab in the mating direction.

4. The USB connector as claimed in claim 3, wherein the insulative housing has a base section and a pair of projections defined on the base section, and wherein the shielding shell defines a pair of holes for engaging with corresponding projections of the housing.

5. The USB connector as claimed in claim 4, wherein the housing comprises a mating section extending from the base section with the passageways being defined therein.

6. The USB connector as claimed in claim 1, wherein the free end of the curved portion extends outwardly toward corresponding at least one wall.

7. An electrical connector, comprising:
an insulative housing defining a plurality of passageways therein;
a plurality of conductive contacts received in the passageways of the insulative housing;
a shielding shell enclosing the insulative housing and integrally comprising two opposite lateral walls, a top wall, a bottom wall, and a chamber defined by the top wall, the bottom wall and the lateral walls; and
at least one of said walls formed with a resilient tab extending into the chamber with a curved portion at a free end which does not project outwardly beyond a contour of the shielding shell.
